(19) United States
(12) Patent Application Publication
(10) Pub. No.: US 2026/0293793 A1
(43) Pub. Date: Oct. 1, 2026

(54) MULTI-MEMBER AGRICULTURAL MACHINE FOR PROCESSING THE GROUND

(71) Applicant: MASCHIO GASPARDO S.P.A., Campodarsego (PD) (IT)

(72) Inventors: Andrea MASCHIO, Morsano al Tagliamento (PN) (IT); Andrea PAULETTO, Limena (PD) (IT); Paolo BARALDI, Padova (IT)

(21) Appl. No.: 19/489,797

(22) PCT Filed: Jun. 7, 2024
(86) PCT No.: PCT/IB2024/055599

§ 371 Date: Dec. 3, 2025

(30) Foreign Application Priority Data
Jun. 7, 2023 (IT) 102023000011592

(51) Int. Cl. A01B 73/04; A01B 21/00; A01B 59/06

(52) U.S. Cl. CPC A01B 73/044; A01B 21/00; A01B 59/066

(57) ABSTRACT

A multi-member agricultural machine (1) for processing the ground comprises a central frame (2) which supports at least three operating members including two lateral members (10, 11) and a rear member (12) with reference to an operating advance direction (A) of the multi-member agricultural machine (1), wherein the lateral members (10, 11) each extend from a side of the central frame (2) and wherein the central frame (2) has at the same side a first headstock (13) for attachment to a tractor and a second headstock (14), which is distal from the first headstock, for attachment of the rear member (12) and, at the side opposite the headstocks (13, 14), a carriage (15) for support on the ground.

### DESCRIPTION

The present invention relates to a multi-member agricultural machine for processing the ground, of the type including the features mentioned in the preamble of the main claim.

In the field of agricultural machines for processing the ground and in particular for preparing the seed bed, it is known to adopt architectures with multiple operating members which generally use two paired members which can be pivoted from an extended operating position, in which the operating members are contiguous with tools which face the ground to be processed in a condition of maximum working width, and a transport position, in which the operating members are raised one behind the other in a condition of minimum spatial requirement. When rotary harrows with multiple rotors with a vertical axis are used as operating members, the machine constructed in this manner is called a folding rotary harrow.

However, the working width of such harrows cannot exceed from 6 to 8 metres because of the road dimensions when the machine is folded for transport. The height limit for road travel is in fact 4 metres and a foldable machine with a working width of 8 metres, when folded for transport, has a total height no less than 4 m which has to be added to the distance raised from the ground necessary for transport. In fact, this limit would inevitably be exceeded.

Furthermore, an excessive height in the transport position would reduce the stability of the machine in this phase.

It is further known to construct milling machines which are capable of exceeding these limits for operating width. In this case, the operating members are milling cutters with a horizontal axis and require more complex architectures, for example, constructed in a towed version.

However, it is not the case that such an architecture has been adopted for rotary harrows and even less so in machines of the carried or semi-carried type. On the other hand, towed agricultural machines, that is to say, ones provided with an attachment to the tractor by means of a drawbar which allows rotation relative to the vertical axis between the tractor and machine have many additional complex features because they cannot travel on roads without prior road type-approval. This type-approval requires inter alia that the machine be equipped with autonomous installations, particularly a braking system. This involves evident additional complications, costs and weight. Furthermore, the manoeuvrability of such machines is generally less with respect to the carried machines. It may be noted that, in this context, the term “carried machine” is preferably intended to be understood to be a machine which is configured to integrally transmit its own weight to the road by means of a tractor. However, the term “semi-carried machine” is preferably intended to be understood to be a machine which is configured to partially transmit its own weight to the road by means of one or more wheels which are fitted to the machine itself.

Examples of multi-member agricultural machines for processing the ground are described in EP0900515A2, FR2696070A1, EP3491905B1, WO2022/214668A1,FR3085101A1 or FR3102645A1.

The problem addressed by the present invention is to provide a multi-member agricultural machine for processing the ground which is structurally and functionally configured to overcome at least some of the disadvantages set out with reference to the cited prior art.

In the context of this problem, an important object of the invention is to provide such an agricultural machine which is suitable for road transport.

Another object of the invention is to provide an agricultural machine which can be constructed in a carried or semi-carried configuration.

Another object is to provide an agricultural machine which can be used modularly.

This problem is solved and these objects are achieved, at least partially, by an agricultural machine which is constructed according to the present invention.

According to an important aspect of the invention, a multi-member agricultural machine for processing the ground comprises a central frame which supports at least three operating members including two lateral members and a rear member with reference to an operating advance direction of the machine, wherein the lateral members each extend from a side of the central frame.

Preferably, the central frame has at the same side (particularly upper side) a first headstock for attachment to a tractor and a second headstock, which is distal from the first headstock, for attachment of the rear member. Preferably, there is provided on the central frame, at the side opposite the first and second headstocks (particularly lower side), a carriage for support on the ground. The carriage may comprise, for example, an axle which carries one or more wheels.

In a preferred embodiment of the invention, all the operating members are constituted by rotary harrows with rotors with a vertical axis. The invention further envisages the possibility that the operating members are constituted by other agricultural machines which are known per se, for example, milling machines with a horizontal axis.

In a preferred configuration, the carriage is positioned on the central frame with an axle in a position between the first and second headstock. It is thereby possible to configure the machine to be constructed in a carried version and where applicable to use the carriage to support the machine at least partially, where applicable in addition to the support provided by the three-point linkage of the tractor. Advantageously, the machine is particularly compact. Furthermore, it is not strictly necessary to use pivoting wheels because the proximity of the axle of the carriage to the three-point linkage of the first headstock means that, during the steering, the wheels of the carriage approximately follow the steering course of the rear wheels of the tractor.

In some embodiments, the rear member comprises an individual headstock for attachment, in particular for attaching to the second headstock.

According to a desired feature in the present invention, the axle of the carriage is proximal with respect to the first headstock and preferably distal from the attachment headstock of the rear member or distal from the second headstock. This feature further improves the above-indicated advantages and in particular, by bringing the wheels axis of the carriage into a position near the rear axle of the tractor which guides and tows the agricultural machine, the sliding on the ground of the wheels of the carriage is reduced during the turns of the tractor.

Preferably, the axle of the carriage has a position which, with reference to the operating advance direction of the machine, is nearer the first headstock than the attachment headstock of the rear member.

Preferably, the axle of the carriage has a position which, with reference to the operating advance direction of the machine, is nearer the first headstock than the centre of the machine.

In some embodiments, the axle of the carriage may be located substantially at the centre between the first headstock and the second headstock or may be proximal to the first headstock and distal from the second headstock, or vice versa.

Preferably, the axle of the carriage is located on the central frame and with respect to the first and second headstocks in a position included within the projection of the lateral members on the central frame. The first headstock is preferably provided for three-point linkage of the carried or semi-carried type. In this manner, the manageability of the machine is advantageously improved both in an operating working condition and in the transport phase.

Preferably, the second headstock is configured for three-point linkage of the carried type. This affords advantages in mounting the rear member, allowing the use of harrows of the commercial type from normal production.

By providing on the central frame two wings which are each hinged to a respective side of the central frame and with actuation means between each wing and the central frame in order to pivot the wings towards and away from an operating position, in which the wings are extended in mutually opposite positions, and providing a lateral member which is mounted on each wing in a movable manner towards and away from an operating working position, in which the respective lateral member is moved on the wing in a distal position from the headstocks of the central frame, it becomes possible to substantially make the machine more compact when in a transport position while benefitting from a maximum working width which is extremely advantageous. The machine can advantageously be constructed in a version which is authorized for road travel while achieving a maximum working width in an operating position of 10 metres and above.

In this case, it is preferable for the lateral members to be slidingly guided on the wings, where applicable providing to this end a respective slide on each wing.

It is further preferable that there are provided between each lateral member and the respective wing (or the central frame) actuation means for moving in translation along the wing the respective lateral member towards and away from the respective operating working position. This facilitates the transition of the machine from the transport position to the working position, and vice versa.

Advantageously, the actuation means which are provided for the movement of the lateral members on the respective wing may be constituted by extraction jacks which are attached at one side to the sliding lateral member and at the other side to the frame of the respective wing. In some embodiments, there is provision for using a single jack for each wing. Alternatively, there is provision for using a pair of opposite and coaxial jacks which are attached by the respective bases, one of the jacks being provided for moving (in a reversible manner) the member towards the headstocks over a limited sliding section and so that the corresponding lateral member does not have interference with the carriage of the central frame, in particular in the pivoting phase of the corresponding wing away from and towards the transport position, the other of the jacks being provided for completely retracting (in a reversible manner) the lateral member towards the central frame and the carriage once the corresponding wing is completely raised for transport. This applies vice versa for the operations of extending the wings and the lateral members into the working position. This allows effective control of the position of the lateral members so that they do not have interference with the central fame in any of the transitional positions from and towards the operating and transport positions.

In some embodiments, the actuation means which are provided for the movement of the lateral members on the respective wing and for pivoting the respective wing with respect to the headstocks of the central frame therefore comprise an adjustable, two-stage extraction jack, that is to say, two jacks in a pairing, the cylinders of which are coupled base against base so as to have opposite shanks with independent control.

If the rear member is removably engaged with the central frame, it is also possible to use the machine in a compact version, provided only with the lateral members or to use only the rear member individually.

By providing between the rear member and the second headstock a three-point linkage so that, when the rear member is disengaged from the central frame, it can alternatively be connected to the three-point linkage of an agricultural tractor, the object indicated above is clearly facilitated.

If the free distance between the lateral members when they are in the respective operating working positions is less than or equal to an operating working width of the rear member, there is afforded an advantageous slight overlapping of the working areas of the lateral and rear members, eliminating the need for additional means for processing the zones which are not operated by the members themselves or which are included by the footprint of the tyres or tracks of the tractor.

The features and advantages of the invention will be better appreciated from the detailed description of a preferred, though non-exclusive, embodiment thereof which is illustrated by way of non-limiting example with reference to the appended drawings, in which:

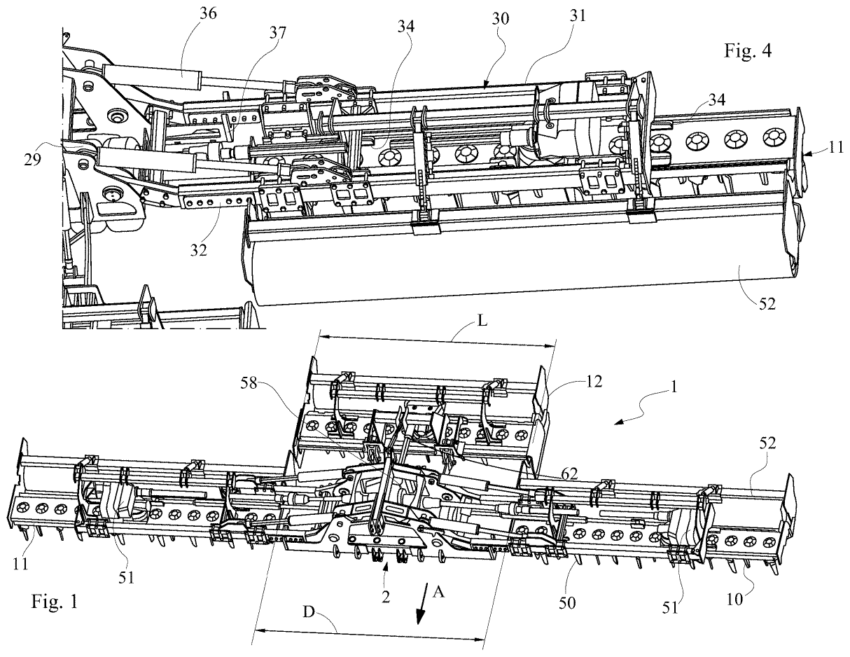

FIG. 1 is a perspective front view of an agricultural machine according to the invention in an operating working position;

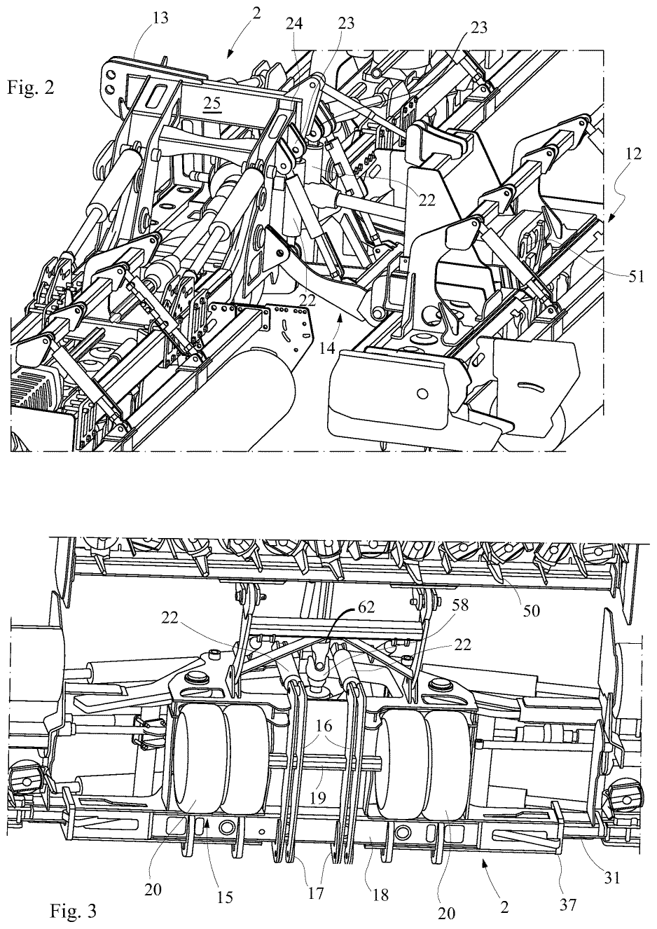

FIG. 2 is a partial perspective rear view of the same machine of FIG. 1;

FIG. 3 is a perspective bottom view of the same machine of FIG. 1;

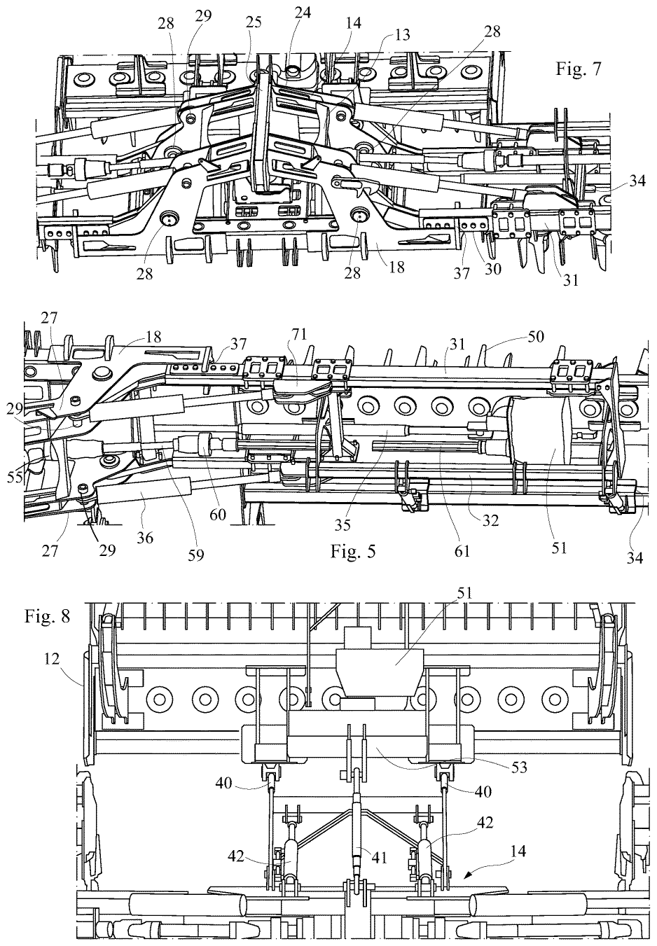

FIGS. 4 and 5 are perspective views, drawn to an enlarged scale, of the machine of the preceding Figures;

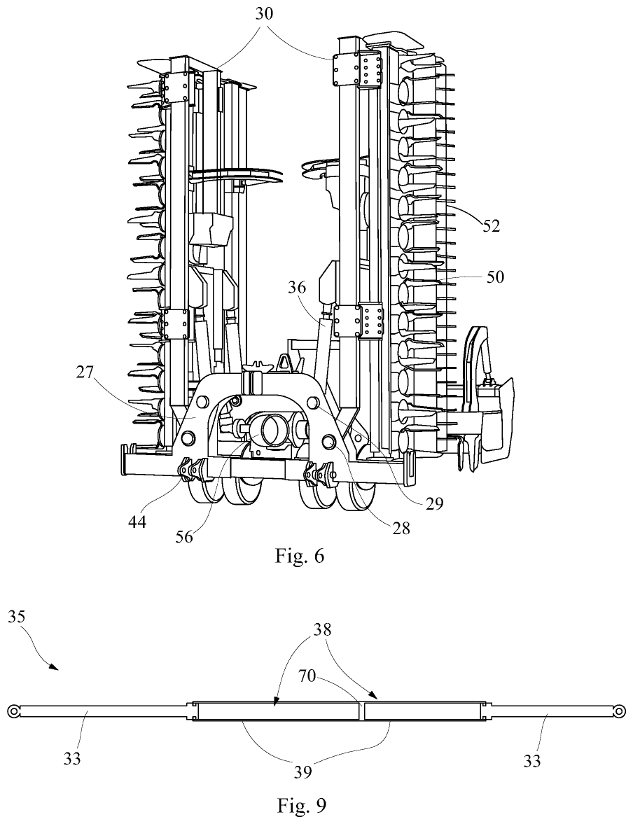

FIG. 6 is a perspective view of the machine of the preceding Figures in a transport position;

FIG. 7 is a perspective view of a central portion of the machine of the preceding Figures taken from the front;

FIG. 8 is a plan view of a rear portion of the machine of the preceding Figures;

FIG. 9 is a longitudinally sectioned view of a detail of actuation means of the machine of the preceding Figures;

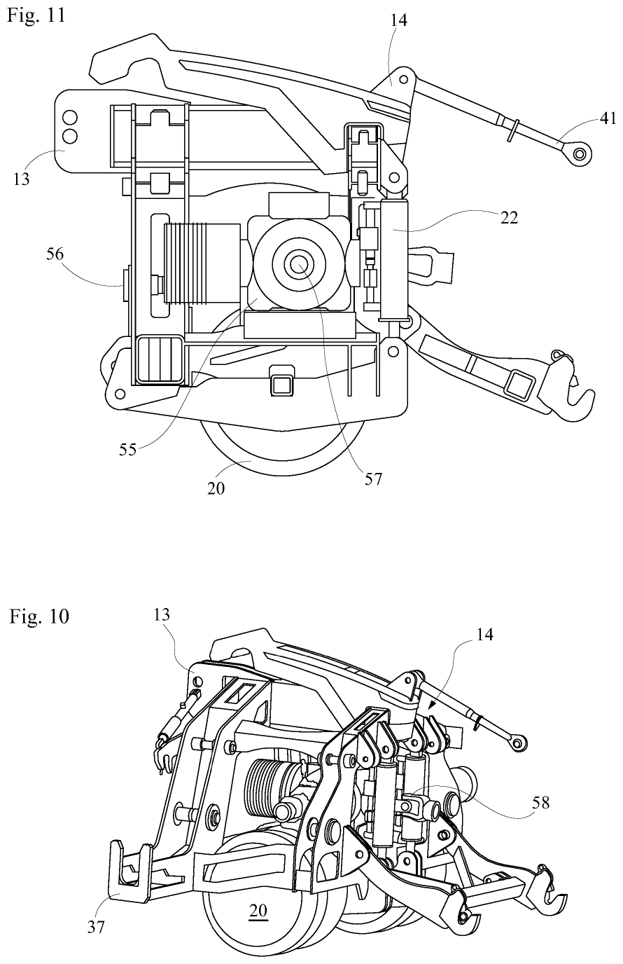

FIGS. 10 and 11 are perspective and cross-sectional views of a detail of the central fame of the machine of the preceding Figures, respectively.

In the Figures, there is generally designated with 1 an agricultural machine for processing the ground which is constructed according to the present invention. The machine 1 comprises a central frame 2 which acts as a support for three operating members including two lateral members 10, 11 and a rear member 12. The position of such operating members is given with reference to an operating advance direction or working direction of the machine which is indicated by the arrow A, as shown in the example of FIG. 1.

Preferably, the lateral members 10, 11 are mutually identical, as is the assembly method thereof on the central frame (specularly symmetrical) and therefore only one of them will be described in detail.

The lateral members 10, 11 preferably each extend from a side of the central frame 2, which is opposite with respect to the direction A. In turn, the central frame 2 carries at the same side (upper side) a first headstock 13 for attachment to a tractor (not illustrated) and a second headstock 14, which is distal from the first one, for attaching the rear member 12, as shown in the example of FIG. 2.

With reference to the example of FIG. 3, at the opposite side (lower side) to the headstocks 13, 14, there is preferably mounted a carriage 15 with two arms 16 which are hinged by means of connection plates 17 to a lower beam 18 of the headstock 13. The carriage 15 is preferably provided with an axle 19 which is fixed to the arms 16 and which is provided with wheels 20, more particularly a double pair of twinned wheels. The above-mentioned wheels can be replaced by rollers, belts or elements for support on the ground with a different structure without altering the result of the invention. The carriage 15 is configured to support, or preferably to contribute to supporting, the mass of the machine 1 on the ground and is actuated in order to lower or raise the wheels 20 away from and towards the two headstocks 13, 14 by means of a pair of actuators 22, preferably the hydraulic jacks, which are interposed between the arms 16 and respective connection plates 23 which are fixedly joined to an upper beam 24 of the second headstock 14, as shown in the example of FIG. 2. Preferably, the two headstocks are then fixedly joined to each other by means of longitudinal members 25. Both the first and the second headstock 13, 14 have a lateral box-shaped structure 27 which is open and in which there are mounted (at both sides) a respective first and second pair of pins 28, 29, as shown in the examples of FIGS. 5, 6. There is mounted on the pair of pins 28 a respective wing 30 which can pivot between a first operating or working position, in which the wings 30 are extended bilaterally with respect to the two headstocks 13, 14, and a second transport position, in which the wings are brought back into a raised position, with minimal dimensions, which is approximately vertical, as shown in the example of FIG. 6.

The wings 30 each comprise a first longitudinal member 31 and a second longitudinal member 32 which are parallel and spaced apart and can be seen in the example of FIG. 5. In the operating position, the first longitudinal members 31 of the wings 30 are preferably received in an interlocking manner in a respective seat of a bracket 37 which projects from the beam 18 of the first headstock 13, as shown in the examples in FIGS. 4, 7. The first and second longitudinal members 31, 32 act as a sliding guide for slides 34, by means of which each of the lateral members 10, 11 is supported on the central frame and is movable by sliding on the respective wing 30 by means of respective actuation means 35, preferably of the type with a hydraulic jack.

In some embodiments, there is provision for using actuation means with a single jack which is controlled by a positional control unit which correlates the position of the lateral member during movement along the respective wing with the raising of the wing into the transport position.

Alternatively and preferably, it is possible to use double-stage jacks, that is to say, two jacks 38 in pairs, the cylinders 39 of which are coupled base 70 against base 70, so as to have opposite shanks 33 with independent control, as shown in the example of FIG. 9. This solution allows the production of a total working width of 10 m or more. Taking a machine 1 with an operating working width of 10 m, in order to close the machine and to carry out the road transport, it is necessary to compress the machine by drawing back the lateral members 10, 11 towards each other as far as the width of 9 m, subsequently to act on the closure jacks of the wings 30 and, once the members 10, 11 are in a vertical position, to complete the return of the lateral members towards the central frame 2 until reaching a total height of 4 m.

Therefore, it is preferable that the complete return of the lateral members 10, 11 is not carried out when the machine 1 is open otherwise the lateral members could be introduced inside the central frame 2.

This certainty is precisely achieved preferably using a single extraction jack of each lateral member 10, 11 which is provided with sensors (not illustrated) in order to avoid the manoeuvre mentioned above or, preferably, with a pair of jacks 38 which are constructed as indicated above by coupling two cylinders 39 which are securely connected in continuation of each other. With a first cylinder, the partial return of the corresponding lateral member is carried out (reduction of the working width, in the example indicated to 9 m) and with the second cylinder, with wings raised into a transport position, the lowering of the members towards the central frame is carried out (reduction of the transport height to 4 m).

In this manner, it is further possible to automate all these steps in a single remote control without encumbering the machine with sensors which are not generally reliable, particularly in agricultural environments.

Actuation means 36, preferably of the jack type, are used in order to manoeuvre the wings between the working and transport positions. They are secured to the headstocks 13, 14 by means of the pins 29 and are secured to the corresponding wing at the opposite side, as shown in the example of FIG. 4. The actuation means 36 are secured to the respective wing (or each wing is secured to the central frame) in such a manner that the lateral members are freely pivotable (floating) for both a positive (upwards) limited pivoting action and a negative (downwards) limited pivoted action, for example, by means of slots 71 (which can be seen in the example of FIG. 5) which allow a limited excursion of the hinged members or, preferably, by leaving open the hydraulic circuit of the actuation means 36 in a working position so that the lateral members 10, 11 are free to follow the inclination of the ground. In this manner, the structure is substantially less stressed and there is also obtained a greater constancy of the working depth.

There is also provision for the possibility that these actuation means 36 can be used to contribute to actuating the sliding of the slides 34 along the wings 30 so that in a first path of the actuation means 36 the wings are lowered from the transport position (raised) to the working position (extended) but with the respective lateral members 10, 11 placed behind the central frame and, for another path of the actuation means 36, the lateral members are caused to slide together with the respective slide 34 along the respective wing as far as the completely open state of the machine 1. However, it is preferable for the actuation means 36 which are allocated to the opening and closing of the wings to perform only this function and for the jacks 38 for extracting the lateral members to be independent.

It may be noted that the carriage 15 is positioned on the central frame with the axle 19 located in a position contained between the first and second headstocks 13, 14 and preferably proximal to the first headstock 13 and distal from the second headstock 14 or distal from the attachment headstock 53 of the rear member 12, as can be seen in the example in FIG. 3.

In some embodiments, the axle 19 of the carriage is located on the central frame and with respect to the headstocks 13, 14 in a position included in the projection of the lateral members 10, 11 on the central frame with positioning of the wheels 20 which is as far as possible moved towards the first headstock 13. There are thereby afforded a number of advantages which characterize the machine 1. Firstly, there is obtained a favourable longitudinal compactness of the entire machine 1 which substantially improves the manoeuvrability thereof. Furthermore, it is possible for, during steering, the trajectory of the wheels 20 to coincide approximately with the trajectory which is travelled by the rear wheels of the tractor (apart from minimal skidding), thereby obtaining a situation in which it is possible to provide a carried machine, the support wheels of which, while not being pivoting wheels, are not forced to move laterally in translation significantly during the steering (or are forced to move but only to a minimal extent). This further allows unloading during the working phase of the machine 1 of at least some of the weight of the structure on the ground, limiting the load on the three-point linkages of the tractor. Furthermore, this same prerogative also provides an advantageous effect for transporting the machine and reduces the wear of the wheels themselves. Finally, this arrangement, while providing adequate support for the machine in the working and transport phases, allows the machine 1 to be provided in the version which is carried or semi-carried, which overcomes the need for providing for autonomous braking of the wheels 20 and does not involve the road type-approval of the machine 1.

There is preferably articulated to the second headstock 14 a three-point linkage including two tool-carrying arms 40 and an adjustable strut 41. The arms 40 can be actuated by means of a hydraulically actuated lifting mechanism 42 and can be provided with rapid-fit attachments, as shown in the example in FIG. 8.

As shown in the example of FIG. 6, there are fixedly joined to the first headstock 13 in turn attachment elements 44 for the three-point linkage of an agricultural tractor.

It being possible to raise the machine 1 completely by means of the three-point linkage of a tractor, the machine 1 constitutes a carried equipment item. However, the machine is semi-carried when it is secured only by means of the two lower points of the three-point linkage. It may be noted that, independently of the raising position operated by means of the three-point linkage of the first headstock 13, it is always possible to supply the actuators 22 of the carriage 15 so as to contribute to lifting the machine 1. The contribution to the raising action is adjustable by varying the supply pressure of the actuators 22. Alternatively, there is provided a load control system on the axle 19, by means of a mechanical damper or by controlling the pressure of the cylinders by means of a pressure sensor which can be displayed remotely.

It may be observed that each lateral member 10, 11 and the rear member 12 preferably comprise a plurality of tools 50 which are known per se, the actuation of which is controlled by a gearbox 51 and is where applicable provided with a roller 52.

The rear member 12 is preferably in the form of a rotary harrow which can be used autonomously. This allows this member to be used independently of the machine 1 for operations in which a large working width is not required, or in a form integrated in the machine 1, as illustrated in the appended drawings.

To this end, the rear member 12 is provided with an individual attachment headstock 53 which is connected to the three-point linkage in a substantially conventional manner and all the tools and instruments which are normally provided for a conventional rotary harrow, as shown in the example of FIG. 8. However, it is selected with sufficient dimensions to provide a working operating width L so as to be equal to or preferably slightly exceed the free distance D under the central frame between the two lateral members 10, 11 when the machine 1 is extended with wings to the maximum operating width, as shown in the example of FIG. 1. In this manner, the harrowing action of the three operating members with slight overlap relative to each other is ensured.

Finally, there is mounted on the central frame 2 a gearbox 55 which is provided to be supplied via a cardan shaft which is not illustrated in the region of a movement input shaft 56 thereof. The gearbox 55 preferably comprises movement output shafts 57 for the lateral members 58 for the rear member, as shown in the examples of FIGS. 10, 11. All the operations between the gearbox 55 and the gearboxes 51 are carried out using cardan shafts. For the actuation of each of the lateral members, there is used a first cardan shaft 59 which connects the respective output shafts 57 to an intermediate support 60. The intermediate support 60 is in turn connected to the gearbox 51 by means of a second cardan shaft 61 which is preferably of the type with triple extraction, as shown in the example in FIG. 5, so as to allow the necessary lengthening actions following the movement of the respective lateral member 10, 11 on the respective wing 30.

Similarly, the output shaft 58 is connected to the gearbox 51 of the rear member by means of an additional cardan shaft 62, which can be seen in the example in FIG. 1.

The fact that the machine 1 preferably comprises two cardan shafts 59, 61 for each of the lateral members has a number of advantages. Firstly, it is thereby possible to effectively transmit the torque over substantial distances (in some embodiments, the lateral members can be extended by virtually 1 metre and the lateral transmission may change from 2 metres with the members retracted to 3 metres with the members completely extended). Furthermore, by splitting the lateral transmission in two, and where applicable supporting it in an intermediate position, it is possible to reduce the vibrations generated by the rotation of the cardan shafts (in some embodiments, the rotation speed of the cardan shafts is in the order of 1000 rpm).

The provision of the triple extraction on the second cardan shaft 61 is also particularly advantageous because it allows the production of an extended overlap between the longitudinal sections of the second cardan shaft, the extended overlap allowing the torque transmitted to be supported more effectively.

The operation of the machine 1 is as follows. Starting from the transport position of FIG. 6, it may be noted that the carriage 15 is actuated in order to ensure the support of the wheels 20 on the ground. As mentioned, given the proximity of the axle 19 to the first attachment headstock 13 including on curves, the fact that the machine 1 is carried and supported on the ground does not give rise to problems. In order to move to the working position, the extraction jacks 38 are actuated, initially bringing about a sliding of the lateral members 10, 11 away from the central frame 2. Once this step is carried out, the descent of the wings 30 into the working position is carried out and, therefore, by continuing the action of the extraction jacks 38, there is brought about the movement of the lateral members along the respective wings up to the position of maximum extension. The support of the wheels 20 on the ground is adjusted as required by means of the actuators 22. The position of the rear member 12 is adjusted by means of the lifting mechanism 42 of the rear three-point linkage.

Therefore, the power take-off of the tractor is actuated in order to rotate the tools 50 of the three operating members 10-12. On headland, the machine 1 is raised for the strict turnaround necessary for reversing travel. The time at which the machine is where applicable completely raised is modest and does not involve problems for the tractor. For the purposes of turning at the headland, it is preferable for the wings 30 to be raised into an intermediate position between the operating working position and the transport position. The pivoting of the wings 30 away from and towards the intermediate position can be controlled by means of a control terminal which is operationally connected to the actuation means 36. In a preferred embodiment, the pivoting of the wings 30 is automated by means of a control terminal which communicates with the tractor, in particular by means of an Isobus protocol.

Once the work is complete, the machine is closed again with the wings 30 brought into the position of FIG. 6 and the lateral members 10, 11 brought back towards the central frame 2 with a transposed cycle with respect to the opening cycle.

The invention thereby solves the problems set out, achieving a number of advantages. In particular, it is necessary to take account of the fact that in the great agricultural enterprises there are always most frequent high-power tractors (from 500 to 600 hp) and that the harrowing with a rotary harrow constrains the vehicle to low advance speeds. This means that, in order to advantageously use the power of these tractors, it is necessary to substantially increase the working width of the equipment.

The advantages achieved with this machine therefore include an increase of productivity with respect to the conventional harrows with smaller dimensions, a reduction of the working time window with a resultant reduction of the risks of bad weather and acceleration of the sowing phase, a reduction of the fuel consumption in proportion relative to the width worked, a complete use of the power available.

Furthermore, these advantages are achieved with a machine which is authorized for road travel, which can operate on variable working widths, for example, from 9 to 10 m, with an improved stability, positioning of the centre of gravity and compactness, capable of ease of separation of the rear member 12 both in order to facilitate the transport and for independent processing operations thereof.

1. A multi-member agricultural machine (1) for processing the ground comprising a central frame (2) which supports at least three operating members including two lateral members (10, 11) and a rear member (12) with reference to an operating advance direction (A) of the multi-member agricultural machine (1), wherein the lateral members (10, 11) each extend from a side of the central frame (2) and wherein the central frame (2) has at the same side a first headstock (13) for attachment to a tractor and a second headstock (14), which is distal from the first headstock, for attachment of the rear member (12) and, at the side opposite the headstocks (13, 14), a carriage (15) for support on the ground, wherein the carriage (15) is positioned on the central frame (2) with an axle (19) in a position between the first and second headstocks (13, 14), and wherein the first headstock (13) is provided for three-point linkage of the carried or semi-carried type.

2. The multi-member agricultural machine (1) according to claim 1, wherein the lateral members (10, 11) and the rear member (12) are rotary harrows.

3. The multi-member agricultural machine (1) according to claim 1, wherein the axle (19) of the carriage is proximal with respect to the first headstock (13).

4. The multi-member agricultural machine (1) according to claim 3, wherein the rear member (12) comprises an individual attachment headstock (53) and wherein the axle (19) of the carriage is distal from the attachment headstock (53) of the rear member.

5. The multi-member agricultural machine (1) according to claim 1, wherein the axle (19) of the carriage is located on the central frame (2) and with respect to the first and second headstocks (13, 14) in a position included within the projection of the lateral members (10, 11) on the central frame (2).

6. The multi-member agricultural machine (1) according to claim 1, wherein the second headstock (14) is provided for three-point linkage of the carried type.

7. The multi-member agricultural machine (1) according to claim 1, comprising two wings (30) which are each hinged to a respective side of both headstocks (13, 14) of the central frame (2) and actuators (36) between each wing (30) and the central frame (2) in order to pivot the wings (30) towards and away from an operating position, in which the wings are extended in mutually opposite positions, a lateral member (10, 11) being mounted on each wing (30) in a movable manner towards and away from an operating working position, in which the respective lateral member (10, 11) is moved on the wing (30) in a distal position from the headstocks (13, 14) of the central frame.

8. The multi-member agricultural machine (1) according to claim 7, wherein the lateral members (10, 11) are slidingly guided on the wings (30).

9. The multi-member agricultural machine (1) according to claim 8, wherein there are provided between each lateral member (10, 11) and the headstocks (13, 14) of the central frame (2) actuators (35) for moving in translation the respective lateral member (10, 11) towards and away from the respective operating working position.

10. The multi-member agricultural machine (1) according to claim 9, wherein the actuators (35) which are provided for the movement of the lateral members (10, 11) on the respective wing (30) comprise extraction jacks (38) which are attached at one side to the lateral member (10, 11) and at the other side to the frame of the respective wing (30).

11. The multi-member agricultural machine (1) according to claim 9, wherein the actuators (35) which are provided for the movement of the lateral members (10, 11) on the respective wing (30) comprise for each wing (30) a pair of opposite and coaxial jacks (38) which are attached by the respective bases (70), one of the jacks (38) being configured for the reversible approach of the lateral member (10, 11) towards the headstocks (13, 14) over such a limited sliding portion that the corresponding lateral member (10, 11) does not have interference with the central frame (2), in particular in the pivoting step of the corresponding wing (30) towards and away from the transport position, the other of the jacks (38) being configured for the complete and reversible retraction of the lateral member (10, 11) towards the central frame (2) and the carriage (15) once the corresponding wing (30) is completely raised for transport.

12. The multi-member agricultural machine (1) according to claim 9, wherein the actuators (35, 36) which are configured for the movement of the lateral members (10, 11) on the respective wing and for the pivoting of the respective wing (30) with respect to the headstocks (13, 14) of the central frame comprise an adjustable, two-stage extraction jack.

13. The multi-member agricultural machine (1) according to claim 1, wherein the rear member (12) is removably engaged with the central frame (2).

14. The multi-member agricultural machine (1) according to claim 13, wherein there is provided between the rear member (12) and the second headstock (14) a three-point linkage so that, when the rear member is disengaged from the central frame (2), it can alternatively be connected to the three-point linkage of an agricultural tractor.

15. The multi-member agricultural machine (1) according to claim 1, wherein the free distance (D) between the lateral members (10, 11) when they are in the respective operating working positions is less than or equal to an operating working width (L) of the rear member (12).

16. The multi-member agricultural machine (1) according to claim 1, wherein the lateral members (10, 11) can be pivoted in a floating manner with respect to the central frame (2) at least in the working position.

17. A multi-member agricultural machine (1) for processing the ground comprising a central frame (2) which supports at least three operating members including two lateral members (10, 11) and a rear member (12) with reference to an operating advance direction (A) of the multi-member agricultural machine (1), wherein the lateral members (10, 11) each extend from a side of the central frame (2) and wherein the central frame (2) has a first headstock (13) for attachment to a tractor, a second headstock (14), which is distal from the first headstock, for attachment of the rear member (12), and a carriage (15) for support on the ground, wherein the carriage (15) is positioned on the central frame (2) with an axle (19) in a position between the first and second headstocks (13, 14), and wherein the axle (19) of the carriage is located on the central frame (2) and with respect to the first and second headstocks (13, 14) in a position included within the projection of the lateral members (10, 11) on the central frame (2).

18. The multi-member agricultural machine (1) according to claim 17, wherein the first headstock (13) is provided for three-point linkage of the carried or semi-carried type.

19. The multi-member agricultural machine (1) according to claim 17, wherein the second headstock (14) is provided for three-point linkage of the carried type.

20. The multi-member agricultural machine (1) according to claim 17, comprising two wings (30) which are each hinged to a respective side of both headstocks (13, 14) of the central frame (2) and actuators (36) between each wing (30) and the central frame (2) in order to pivot the wings (30) towards and away from an operating position, in which the wings are extended in mutually opposite positions, a lateral member (10, 11) being mounted on each wing (30) in a movable manner towards and away from an operating working position, in which the respective lateral member (10, 11) is moved on the wing (30) in a distal position from the headstocks (13, 14) of the central frame.
